(19) United States
(12) Patent Application Publication
(10) Pub. No.: US 2009/0196798 A1
(43) Pub. Date: Aug. 6, 2009

(54) Barrier with Low Extractables and Resealing Properties

(76) Inventors: Robert Sassa, Newark, DE (US); Kevin Dove, Wilmington, DE (US); Sonia Cooper, Wilmington, DE (US)

Correspondence Address: Allan M. Wheatcraft;W. L. Gore & Associates, Inc., P.O. Box 9206, 551 Paper Mill Road, Newark, DE, 19714-9206, US

(21) Appl. No.: 12/026,914

(22) Filed: Feb. 6, 2008

(51) Int. Cl. B01L 3/00; B01L 11/00; C08F 16/24

(52) U.S. Cl. 422/102; 422/99; 156/60; 526/247

(57) ABSTRACT

A barrier with excellent sealability, resealability, and low extractables, used as a septum.

### FIELD OF THE INVENTION

This invention relates to a barrier with low extractables and with resealing properties.

### BACKGROUND OF THE INVENTION

Septa are barriers which are used to isolate a substance, single or multi-component, from its surrounding environment and restrict mass transport between the inside and outside environments. Septa are used in many fields where sample collection and/or chemical analysis are common (e.g. chemical industries, biotechnology, pharmaceutical industry, environmental labs, and academia), as well as in chemical storage and synthesis. A typical setup to isolate a substance using a septum involves placing the substance of interest in a container, for example a glass vial with threaded top, placing the septum over the opening to the container such that the opening is entirely covered by the septum, and securing the septum to the container usually by plastic cap designed to screw onto the container's threads. Alternative examples would include crimp-caps, clamped lids, snap lids, and sealed or heat sealed barriers. From these setups, the sample is isolated from its surroundings, and can only be accessed by either removing the septum, or by puncturing the septum with a probe, typically a needle, and withdrawing a desired volume of the substance.

Septa for high performance containment are commonly a composite of multiple polymers. Several types of elastomers have been used to make septa such as silicone, natural rubber, butyl-rubber, and Viton® (a crosslinked fluoroelastomer). In other cases a semi-crystalline polymer such as polytetrafluoroethylene (PTFE) has been used. These types of materials can be used in combination as well. For example, PTFE-silicone composite septa are widely used as the PTFE layer can supply the chemical resistance and barrier properties that are desirable for a septum, and the silicone layer makes the septum more conformable and easier to puncture with a needle than pure PTFE of the same thickness. The crystallinity of the PTFE layer is thought to be responsible for its barrier properties. In addition, the silicone behaves as a compliant and resealable layer.

There are disadvantages with this known PTFE-silicone composite design, however. After puncture by a needle, silicone is well known in the art to be highly permeable to many vapors, especially those from volatile solvents such as dichloromethane, tetrahydrofuran, and toluene. The escaping solvent results in a constantly changing concentration of a sample which could introduce error into analyses. In addition, this can shorten the life-time or shelf-life of a sample, ultimately requiring end users to make new samples. The PTFE layer, being inelastic and stiff in nature, has also been observed to lead to sealing problems even without puncture.

Another known design is made with at least two layers of resilient polymer such as natural and synthetic rubbers, for example, butadiene polymers, and copolymers, neoprene, chloroprene, and the like. The center layer is a resilient material and the bonded adjacent layers are layers that are under radial tension. After being punctured by a needle, the compressed center layer will force the hole to close and thus reseal. This type of design, as with the other known composite designs, is more complex and difficult to manufacture than a septum made from one material. Thus, it would be desirable to have a septum made from a single material which can reseal after being punctured.

It is also well known in the art that silicone contains contaminants which are easily extracted in the presence of common solvents such as toluene, methanol, ethanol, and acetonitrile. These extractables can add peaks to a chromatogram in the form of what are often referred to as ghost peaks. Ghost peaks can overlap with the peaks associated with a sample and introduce error into an analysis or make an analysis impossible. As such it is desirable to have a septum with little or no extractables.

Crosslinked fluoroelastomers such as Viton® and Kalrez® are known, as a septum material. These fluoroelastomers rely on crosslinking to achieve elasticity since in the uncrosslinked state they are low molecular weight gums. The low molecular weight gum-form is used to facilitate processing. Crosslinking occurs in subsequent steps. It is well known in the art that to achieve crosslinking additional monomers and crosslinking agents are added. These crosslinking agents are often a source of extractables. Viton® is also a poor barrier to many common organic solvents such as methanol, tetrahydrofuran, and acetonitrile among others. A resealable, low extractable, material for a septum is desirable.

### SUMMARY OF THE INVENTION

The present invention is a septum comprising fluorothermoplastic elastomer, free from crosslinks, which is simultaneously a barrier layer that reseals itself and offers low, if any, extractables. Resealability, or elasticity, without crosslinking or without the aid of an adjacent layer is achieved by using high molecular weight polymer. The present invention is also surprising in that despite being amorphous, it has been found to be an incredible barrier to permeation of common organic solvents as exemplified in the data to follow. It is well known in the art that crystallinity significantly reduces permeability as compared to amorphous counterparts. However in this invention, we have unexpectedly discovered that low permeability can be achieved in the absence of crystallinity.

The present invention relates to the use of a fluorothermoplastic elastomer that provides a barrier with resealing properties and low extractables. This makes the invention particularly well suited for applications such as septa used in vials for chromatography, films for 96 well plates or within the equipment itself, such as a septum port in a gas chromatograph, all of which may have different areas, thicknesses and so forth. The present invention is a distinct improvement over commercially available septa today in that it offers improved barrier properties after puncture, and has lower extractables in common solvents.

Generally, the present invention provides a septum composed of a fluorothermoplastic elastomer. Preferred embodiments are prepared from tetrafluoroethylene (TFE) and perfluoroalkyl vinyl ethers, and the most preferred are TFE-perfluoromethyl vinyl ether (PMVE) copolymers containing 40 weight-percent or more PMVE.

Specifically, the invention provides an apparatus comprising a fluid containment vessel defining an interior volume, the fluid containment vessel having an access port for accessing the interior volume, and a cap over the access port and sealing the access port, the cap comprising a puncturable barrier comprising fluorothermoplastic elastomer. Preferably, the fluorothermoplastic elastomer comprises a perfluorothermoplastic elastomer. More preferably, the fluorothermoplastic elastomer comprises a copolymer of tetrafluoroethylene and perfluoro(alkyl vinyl ether); wherein the copolymer contains between about 40 and 80 weight percent perfluoro(alkyl vinyl ether), and complementally 60 and 20 weight percent tetrafluoroethylene. The perfluoro(alkyl vinyl ether) is preferably perfluoro(methyl vinyl ether).

In another embodiment, the inventive barrier is a composite comprising a layer of the fluorothermoplastic elastomer and a layer of polytetrafluoroethylene, preferably expanded polytetrafluoroethylene (ePTFE). The function of the ePTFE layer may be to allow for mechanical bonding to another substrate or to provide lubricity. The barrier of this invention is preferably resealable, clean, heat-sealable, and recyclable.

In another aspect, the invention provides a cap for a fluid containment vessel, the cap comprising a body intermatable with the fluid containment vessel, the body defining an aperture, and a puncturable, resealable barrier adjacent to the aperture, the barrier comprising a fluorothermoplastic elastomer.

In other aspects, the invention provides a method of sealing a fluid containment vessel having an access port comprising the step of covering the access port with a barrier comprising a fluorothermoplastic elastomer, and a method of making a fluid containment vessel comprising forming the vessel of a fluorothermoplastic elastomer.

As used herein, “thermoplastic” means a polymer that softens when exposed to heat and returns to its original condition when cooled to room temperature. Such a polymer can be made to soften, flow or take on new shapes, without significant degradation or alteration of the polymer's original condition, by the application of heat or heat and pressure.

As used herein, “elastomer” means a material that upon deformation, to approximately 15% strain, will return to substantially its initial dimensions when released.

As used herein, “fluorothermoplastic elastomer” means a thermoplastic elastomer comprising a polymer with polymer repeat units based on carbon chains containing fluorine, hydrogen, and occasionally other substituents.

As used herein, “per fluorothermoplastic elastomer” means a fluorothermoplastic elastomer comprising a polymer with polymer repeat units based on carbon chains containing fluorine, and occasionally other fully fluorinated substituents.

As used herein, “puncturable” means the ability to force an object from one surface of a material through the material to other surface.

As used herein, “fluid” means a liquid, gas, vapor, suspension, aerosol, or any combination of these.

As used herein, “clean” means less than 0.1% by weight extractables (as per procedure in Example 4) in toluene.

As used herein “resealable” means a maximum solvent loss of less than or equal to 10% (as per procedure in Example 3, in a solvent of dichloromethane and for a duration of 10 days).

### BRIEF DESCRIPTION OF THE DRAWINGS

FIG. 1A is a perspective view of a fluid containment vessel and cap combination including a barrier according to an exemplary embodiment of the present invention.

FIG. 1B is a perspective view of a fluid containment vessel.

FIG. 1C is a perspective view of a cap including a barrier according to an exemplary embodiment of the present invention.

FIG. 1D is a perspective view of a cap including a barrier according to an exemplary embodiment of the present invention.

FIG. 1E is a perspective view of a cap including a barrier according to an exemplary embodiment of the present invention.

FIGS. 2A and 2B are SEMs of a prior art barrier.

FIGS. 2C and 2D are SEMs of a barrier according to an exemplary embodiment of the present invention.

FIG. 3 is an exploded perspective view of a serum or ultrapure chemical storage vessel including a barrier according to an exemplary embodiment of the present invention.

FIGS. 4A and 4B are perspective views of a pharmaceutical packaging vial including a barrier according to an exemplary embodiment of the present invention.

FIG. 4C is a perspective view of a cap including a barrier according to an exemplary embodiment of the present invention.

FIG. 5A is a perspective view of a chemical reactor including a barrier according to an exemplary embodiment of the present invention.

FIG. 5B is a perspective view of a barrier, according to an exemplary embodiment of the present invention, for a chemical reactor.

FIG. 6A is a perspective view of a Well plate with capped tubes.

FIG. 6B is a perspective view of a cap mat barrier, according to an exemplary embodiment of the present invention, for the Well plate of FIG. 6A.

FIG. 7 is a schematic of a gas chromatograph inlet including a barrier according to an exemplary embodiment of the present invention.

FIG. 8 is a perspective view of a liquid chromatograph inlet including a barrier according to an exemplary embodiment of the present invention.

### DETAILED DESCRIPTION OF THE INVENTION

The present invention relates to the use of a fluorothermoplastic elastomer that provides a barrier with resealing properties and low extractables. This makes the invention particularly well suited for applications such as septa used in vials for chromatography or within the equipment itself, such as a septum port in a gas chromatograph, all of which may have different areas, thicknesses and so forth. The present invention is a distinct improvement over commercially available septa today in that it offers improved barrier properties from a single material both before and after puncture, and has lower extractables in common solvents.

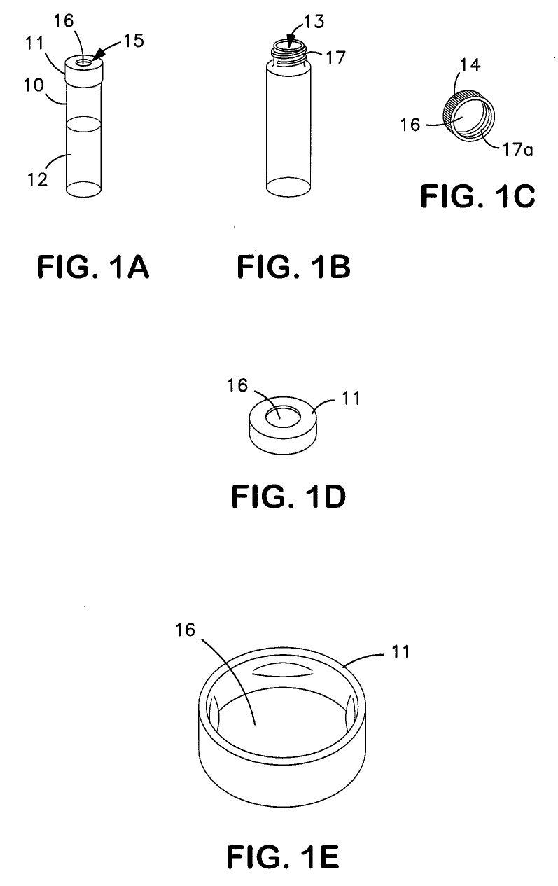

FIGS. 1A-1E illustrate exemplary embodiments of the present invention. FIG. 1A shows a fluid containment vessel 10 and a cap 11. Fluid containment vessel 10 has a fluid 12 contained within it and an access port 13 (FIG. 1B). Cap 11 is attached to fluid containment vessel 10 over access port 13. Cap 11 comprises a body 14 (FIG. 1C) intermatable with fluid containment vessel 10. Body 14 of cap 13 defines an aperture 15. Adjacent aperture 15 is barrier 16. Barrier 16 covers aperture 15 and is attached to cap 11 by any means known in the art, for example, by friction fit, snap fit, adhesive, etc. Barrier 16 preferably comprises a fluorothermoplastic elastomer. Preferred embodiments are fluorothermoplastic elastomer prepared from tetrafluoroethylene (TFE) and perfluoroalkyl vinyl ethers, and the most preferred are TFE-perfluoro(methyl vinyl ether) copolymers containing 40 weight-percent (wt %) or more perfluoro(methyl vinyl ether). Weight contents of PMVE can include but are not limited to 50 wt % PVME, 60 wt % PMVE, and 70 wt % PMVE, with 60 wt % being the most preferable. Weight percent is determined by Fourier Transform Infrared Spectroscopy as described in U.S. Pat. No. 7,049,380, issued May 23, 2006 and titled, “Thermoplastic Copolymer of Tetrafluoroethylene and Perfluoromethyl Vinyl Ether and Medical Device Employing the Copolymer,” which is incorporated herein by reference in its entirety.

In the embodiments illustrated in FIGS. 1A and 1B, fluid containment vessel 10 is a vial designed to contain any type of fluid 12 which is desired to be accessed via access port 13 of fluid containment vessel 10 by, for example, a needle inserted through barrier 16 from the exterior to the interior volume defined by fluid containment vessel 10 containing fluid 12. In the illustrated embodiment, cap 11 is attached to fluid containment vessel 10 by means of threads 17 formed in the neck of fluid containment vessel 10 and corresponding intermating threads 17a formed in cap 11. Alternatively, as illustrated in FIG. 1D, cap 11 may be designed for a crimp fit over fluid containment vessel 10 (which would not include threads 17 in this embodiment). In this embodiment, for example, body 14 may comprise a crimpable plastic or metal material. Also alternatively, cap 11 may be designed for a snap fit, as illustrated in FIG. 1E, with fluid containment vessel 10.

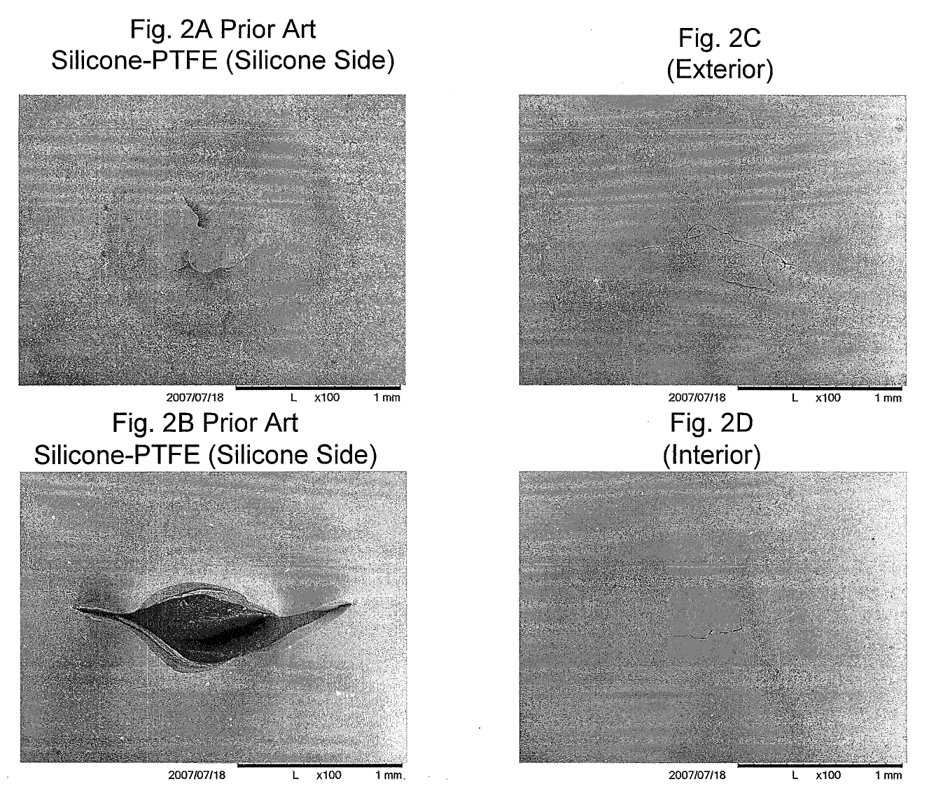

The present invention provides distinct advantages over the most common barriers currently used, namely a two-component laminate of PTFE and silicone. Because the barriers are designed to be punctured by a needle, one important property of the barrier is that it be easily punctured. More importantly, barrier 16 of the present invention reseals itself much better than the prior art alternative. With reference to FIGS. 2A-2D, the resealability of the present invention is illustrated. The prior art silicone-PTFE barrier was punctured five times and SEMs were taken of the resulting barrier. FIG. 2A is a SEM of the silicone (exterior side of the barrier). The opening formed by the needle can clearly be seen in that silicone. FIG. 2B illustrates the PTFE side of the prior art barrier. As can be seen, the needle has created a non-resealing tear in the PTFE. It is possible for any volatile solvent or other fluid contained within fluid containment vessel 10 to escape through the tear and hole formed in this prior art barrier. By contrast, FIG. 2C is a SEM of the exterior of the inventive barrier 16 after five punctures. No needle hole is visible on this exterior side. FIG. 2D is a SEM of the interior side of inventive barrier 16. No tear or other opening is visible on this side either. Accordingly, the barrier 16 of the present invention is resealable, thereby preventing escape of volatile components contained within fluid containment vessel 10.

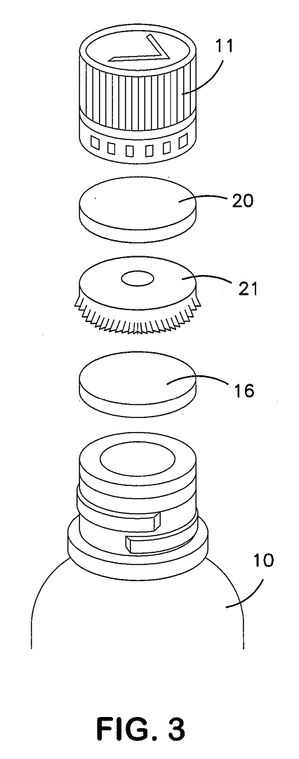

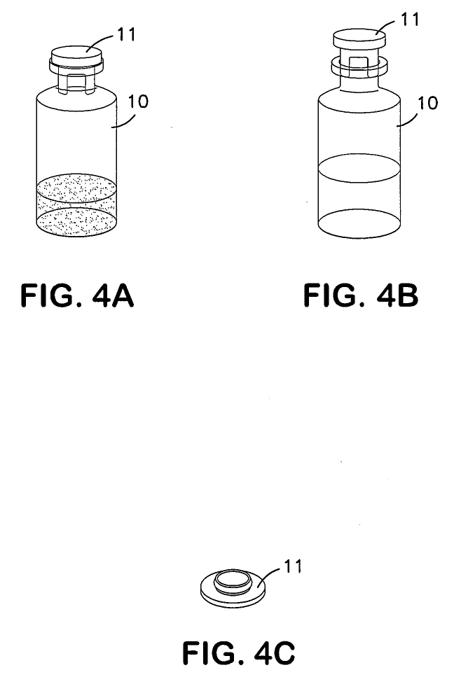

Applications of this invention include the use in storage, synthesis, and analysis of chemicals in chemical and biochemical applications. Examples of storage include but are not limited to containment of chemicals in general, and containment of chemicals that require needle based fluid manipulations including cleaning agents, oxidizers, and high vapor pressure solvents among others. For example, as shown in the exemplary embodiment of FIG. 3, barrier 16 can be used in combination with a cap 11 over fluid containment vessel 10 which comprises a chemical or serum storage vessel. In this exemplary embodiment, a cap liner 20 and metal crimp cap 21 are used in combination with barrier 16 and cap 11. FIG. 4A illustrates fluid containment vessel 10 comprising a pharmaceutical packaging vial. In this embodiment, cap 11 may either comprise the barrier itself (i.e., cap 11 is the barrier) (see FIG. 4C) or cap 11 may define an aperture having barrier 16 exposed adjacent to it. FIG. 4A shows the vial containing a lyophilized cake with the cap in the closed position; FIG. 4B shows it in the open, lyophilizing position with liquid.

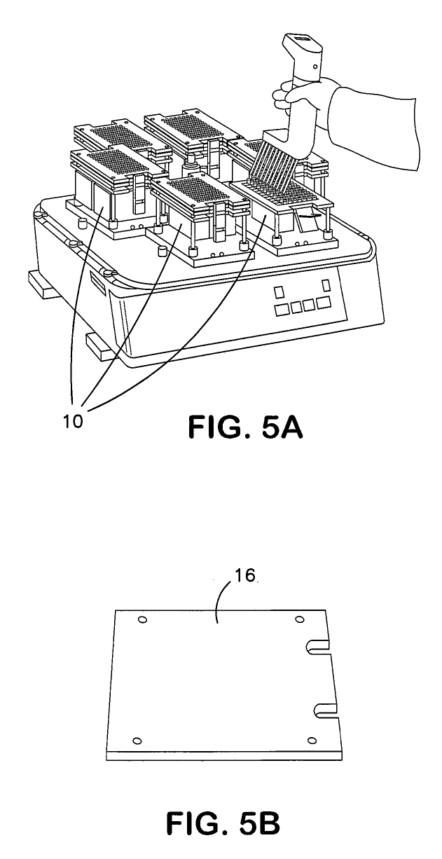

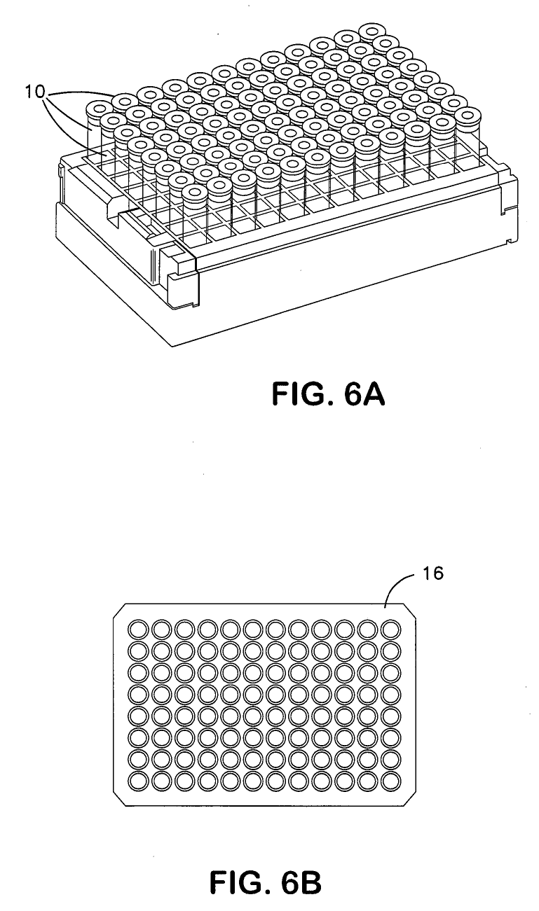

The current invention has uses in synthesis which include but are not limited to reaction chemistry, combinatorial chemistry, pharmaceutical preparation, biochemical preparation, and diagnostic reactions. FIG. 5A illustrates a chemical reactor comprising a plurality of fluid containment vessels 10 which in this embodiment are glass reactor vessels. Barrier 16, in this embodiment and as shown in FIG. 5B, is designed to be of the appropriate shape to cover vessel 10. FIG. 6A illustrates a microplate with capped tubes, which comprises a plurality of fluid containment vessels 10 in the form of capped tubes. In this embodiment, there are ninety-six such vessels 10. Barrier 16, in this embodiment, is illustrated in FIG. 6B which is designed in a unitary cap mat to fit over all of vessel 10. That is, in this embodiment, barrier 16 is a ninety-six Well plate cap mat.

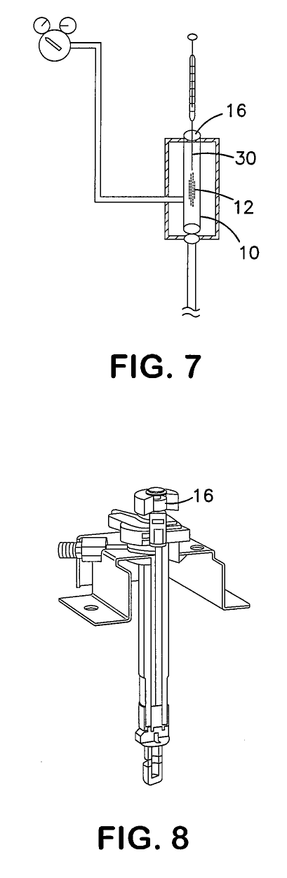

This thermoplastic fluoroelastomer is particularly useful in the area of analysis. Analysis would include but is not limited to gas chromatography, liquid chromatography, headspace analysis, ion chromatography, environmental trace analysis, forensic analysis, standard preparation and storage vessels. FIG. 7 illustrates barrier 16 used in a heated inlet to allow needle injection (30) of a sample into a sweep gas (12) which carries the sample into the inlet (10) of the gas chromatography column. FIG. 8 illustrates a liquid chromatograph having barrier 16 disposed over the inlet port to the liquid chromatograph unit.

Additionally uses of the current invention include but are not limited to high throughput screening of molecules for new drug investigations, storage of drug compound candidates in libraries (compound management).

This thermoplastic fluoroelastomer can be fabricated in many forms which include but are not limited to septa, plates, sheets, stoppers, plugs, ports, containers, bags, pouches, films, thin film composites.

Implementation of the invention includes but is not limited to the use of the thermoplastic fluoroelastomer as an entire article or vessel, a portion of the article, or simply the surface that will be in contact with a sample. From these options, the most preferred embodiment being an article made entirely from thermoplastic fluoroelastomer. Methods of manufacturing inventive articles include but are not limited to extrusion, compression molding, injection molding, and solvent casting.

### EXAMPLES

### Example 1

### Sample Fabrication

Thermoplastic fluoroelastomer pellets were placed into a square die with dimensions 10.1×10.1×0.127 cm³. The pellets were prepared as outlined in U.S. Pat. No. 7,409,380 B1 with perfluoro(methyl vinyl ether) weight percent content of 65±5%. The amount of material added to the die was 24 grams. The die and pellets were lined with Kapton sheets with thickness of 2 mils and placed between two flat stainless steel plates each with a thickness of 1.5 mm. This entire set was placed inside a heated platen press (VAC-Q-LAM) and compression molded using the following procedure:
1. Apply vacuum (˜21 inches Hg) with temperature of 90° F. for 5 min.
2. Hold vacuum, increase plate pressure to 1250 psig, and increase temperature to 483° F. over 60 minutes.
3. Hold vacuum, temperature and plate pressure for 10 minutes.
4. Release vacuum and plate pressure, and cool material to 90° F.

This procedure lead to fluoroelastomer sheets with length and width dimensions matching the die, and a nominal thickness of 1 mm.

The fluoroelastomer sheet-stock was cut into septa using circular die punches appropriate for the cap into which they would be placed. For example, septa intended for use with Shimadzu vials were cut using a die punch with a diameter of 8.6 mm. Likewise, septa intended for use with Fisher vials were cut using a die punch with diameter of 0.345″. A sample's diameter and thickness were at times measured using a video measurement system (Avant 400 Optical Gauging Products) and micrometer (Mitutoyo Absolute, ID-C112CE), respectively. The resulting circular septa were manually placed into a plastic cap which was designed to close around a glass vial. The glass vials used in this study were designed to contain 1.5 mL of solvent and the manufacturers included Fisherbrand (Clear 10-425 screw thread vial) and Shimadzu (Prominence, Part Number 228-45450-91); the septa included with these brands of vials were manually removed from their caps before the thermoplastic fluoroelastomer septa were added.

### Example 2

### Sealability Test

Vials with septa prepared as in Example 1 had their masses recorded (i.e. mass of glass vial, cap and septa combined) using a microbalance (Sartorius MC210 P). Their lids were then removed and each glass vial was filled with ˜1.5 mL of solvent, either toluene (TOL) or dichloromethane (DCM) and subsequently retightened. The filled vials were then immediately weighed and their masses recorded. Each vial's mass was remeasured multiple times for up to 21 days, and the amount of solvent loss was calculated as a percentage of the initial solvent mass using the equation below:

$$Wt . \% Solvent Loss = \frac{( {M}_{0} - {M}_{t} )}{( {M}_{0} - {M}_{v} )} \cdot 100 \%$$

Here, Mₒ is the initial mass of the vial, cap, solvent and septum immediately after adding the solvent, Mₜ is the mass of the same group at some specified time, and Mᵥ is the mass of the same group before the addition of solvent (i.e. the mass of the vial, cap and septum). The results are shown in Table 1, where N=number of samples.

### Example 3

### Resealability Test

Samples from Example 2 were punctured five times using a Thermo Separation Products Spectrasystem AS1000 autosampler with 0.02″ diameter needle, after which their masses were immediately recorded. Samples used in this study had been previously screened for a tight seal to ensure any solvent loss would be due to the needle puncture.

Each sample's mass was recorded over time, and the amount of solvent loss in relation to the amount of solvent in the sample immediately after puncture was determined using the same method as in Example 2. The results are shown in Table 2, where N=number of samples.

### Example 4

### Extractables Test

Samples prepared in Example 1 were analyzed for extractables using a gravimetric method. Seven septa of the fluoroelastomer were each individually placed onto separate Shimadzu vials and tightened to seal 0.5 mL of a solvent. The solvents used in this study included acetonitrile, toluene, methanol, ethanol, and isopropanol. The vials were then inverted for 72 hours in order to allow the solvent to come into contact with septum and allow any extractables in the septum to diffuse into the solvent.

After the 72 hours, the vials were turned up-right, and 7 vials containing the same solvent had their contents poured into a single 43 mm diameter aluminum weigh dish (VWR, Cat.# 25433-052) of known mass. The aluminum pans were then exposed to a nitrogen flow until all of the solvent had completely evaporated. Once dry, each pan's mass was reweighed. The difference between this mass and the pan's original mass was calculated and then normalized to the mass of seven septa. This number, reported as a weight-percentage, was used as the amount of extractables in the material. The results are shown in Table 3, where N=number of samples.

### Example 5

### Plasma Treatment

Fluoroelastomer sheet stock prepared as described Example 1 was plasma treated using a roll-to-roll web coating process (ENERCON INDUSTRIES Corp). Radio frequency plasma was produced by supplying a plasma generator with 2.5 kW of power. The films were treated using a plasma gas formulation composed of 50 l/min of helium, 150 mL/min of acetylene, and 1 l/min of carbon dioxide. The line speed was kept constant at 3 m/min. The plasma treatment was performed to improve adhesion of the fluorothermoplastic elastomer to surfaces.

### Comparative Example 1a

### Sample Fabrication

PTFE-silicone septa (Cat.# 03-391-14) and glass vials (Cat.# 03-391-16) were purchased from Fisher Scientific and assembled as outlined in Example 1

### Comparative Example 1b

### Sample Fabrication

PTFE-silicone septa manufactured by Shimadzu (Prominence, Part Number 228-45450-91) were assembled as outlined in Example 1.

### Comparative Example 2

### Sealability Test

Samples of each comparative type of septa were tested for sealing as outlined in Example 2. The results are listed in Table 1.

### Comparative Example 3

### Resealability Test

Samples of each comparative type of septa were tested for resealing as outlined in Example 3. Samples used in this study had been previously screened for a tight seal to ensure any solvent loss would be due to the needle puncture. The results are listed in Table 2.

### Comparative Example 4

### Extractables Test

Samples of each comparative type of septa were tested for extractables as outlined in Example 4. For the case of PTFE-silicone septa, the septa were punctured five times before the solvent was introduced into the vial. This was necessary to ensure both components of this composite septum were exposed to solvent, and thus allow extraction to occur in both layers as opposed to only the PTFE layer which would have been the case if the septa were not punctured. The other septa types included in this study were not composites, therefore there was no need to puncture them.

The results of this experiment are listed in Table 3.

TABLE 1
Sealability Data*

| | | | | | | Maxi- |
|---|---|---|---|---|---|---|
| | | | | | | mum |
| | | | | | | Solvent |
| | Septum | | | | Number | Loss |
| Example | Type | Vial Brand | Solvent | N | of Days | (wt %) |
| Comparative | PTFE- | FisherBrand | DCM | 10 | 20 | 12.3 |
| Example 1a | Silicone | | | | | |
| Example 1 | Inventive | FisherBrand | DCM | 6 | 20 | 0.0 |
| Comparative | PTFE- | FisherBrand | TOL | 9 | 20 | 0.3 |
| Example 1a | Silicone | | | | | |
| Example 1 | Inventive | FisherBrand | TOL | 6 | 20 | 0.0 |
| Comparative | PTFE- | Shimadzu | DCM | 11 | 13 | 0.3 |
| Example 1b | Silicone | | | | | |
| Example 1 | Inventive | Shimadzu | DCM | 13 | 17 | 0.0 |

*The maximum solvent loss data reported in this table does not include outliers which were assumed to result from defective caps and/or vials and would not be indicative of a septum's ability to seal and prevent solvent loss.

TABLE 2
Resealability Data

| | | | | | | | Maximum |
|---|---|---|---|---|---|---|---|
| | | | | | Number | | Solvent |
| | Septum | | | | of | Number | Loss |
| Example | Type | Vial Brand | Solvent | N | Punctures | of Days | (wt %) |
| Comparative | PTFE- | FisherBrand | TOL | 7 | 1 | 21 | 35.0 |
| Example 1a | Silicone | | | | | | |
| Example 1 | Inventive | FisherBrand | TOL | 6 | 1 | 21 | 0.5 |
| Comparative | PTFE- | FisherBrand | DCM | 6 | 1 | 18 | 51.1 |
| Example 1a | Silicone | | | | | | |
| Example 1 | Inventive | FisherBrand | DCM | 7 | 1 | 16 | 0.0 |
| Comparative | PTFE- | Shimadzu | DCM | 11 | 5 | 9 | 38.2 |
| Example 1b | Silicone | | | | | | |
| Example 1 | Inventive | Shimadzu | DCM | 13 | 5 | 15 | 0.6 |

TABLE 3
Extractables of different septa types expressed as
weight-percent of septum

| | | | Average Extractables |
|---|---|---|---|
| Septum Type | Solvent | N | Content (wt %) |
| Comparative | Acetonitrile | 7 | 0.44 |
| Example 1a | Ethanol | 7 | 0.34 |
| | Isopropanol | 7 | 0.18 |
| | Methanol | 7 | 0.05 |
| | Toluene | 7 | 0.97 |
| Example 1 | Acetonitrile | 7 | 0.00 |
| | Ethanol | 7 | 0.04 |
| | Isopropanol | 7 | 0.00 |
| | Methanol | 7 | 0.00 |
| | Toluene | 7 | 0.02 |

As can be seen from Table 1, inventive Example 1 had 0.0 wt % solvent loss with both toluene and dichloromethane using both different types of vials. This is vastly better than the 12.3% and 0.3% losses reported for the comparative examples. The inventive barrier thus provides much better initial sealability than the comparative examples.

With reference to Table 2, inventive Example 1 showed a maximum of 0.6 wt % solvent loss after being punctured multiple times. This is to be compared with the 35%, 51.1%, and 38.2% losses reported for the comparative examples. The inventive barrier thus provides much better resealability after puncture than the comparative examples.

Finally, with reference to Table 3, the inventive Example 1 shows a maximum of 0.04 wt % extractables, compared with up to 0.97% extractables for the comparative example. The inventive barrier thus has a much lower extractable level, making it a surprisingly pure septum.

What is claimed:

1. An apparatus comprising a fluid containment vessel defining an interior volume, said fluid containment vessel having an access port for accessing said interior volume, and a cap over said access port and sealing said access port, said cap comprising a puncturable barrier comprising fluorothermoplastic elastomer.

2. An apparatus as defined in claim 1 wherein said fluorothermoplastic elastomer comprises a perfluorothernoplastic elastomer.

3. An apparatus as defined in claim 1 wherein said fluorothermoplastic elastomer comprises a copolymer of tetrafluoroethylene and perfluoro(alkyl vinyl ether); wherein the copolymer contains between about 40 and 80 weight percent perfluoro(alkyl vinyl ether) and complementally 60 and 20 weight percent tetrafluoroethylene.

4. An apparatus as defined in claim 3 wherein said perfluoro(alkyl vinyl ether) is perfluoro(methyl vinyl ether).

5. An apparatus as defined in claim 1 wherein said barrier is a composite comprising a layer of said fluorothermoplastic elastomer and further comprising a layer of polytetrafluoroethylene.

6. An apparatus as defined in claim 5 wherein said polytetrafluoroethylene is expanded polytetrafluoroethylene.

7. An apparatus as defined in claim 1 wherein said barrier is resealable.

8. An apparatus as defined in claim 1 wherein said barrier is clean.

9. An apparatus as defined in claim 1 wherein said barrier is heat-sealable.

10. An apparatus as defined in claim 1 wherein said barrier is recyclable.

11. An apparatus as defined in claim 1 wherein said fluid containment vessel is a chromatography sample vial.

12. An apparatus as defined in claim 1 wherein said fluid containment vessel is a reaction chemistry vial.

13. An apparatus as defined in claim 1 wherein said fluid containment vessel is a biological sample vial.

14. An apparatus as defined in claim 1 wherein said fluid containment vessel is an ultra-pure chemical storage vial or tube.

15. An apparatus as defined in claim 1 wherein said fluid containment vessel is a medicine vial.

16. An apparatus comprising a fluid containment vessel defining an interior volume, said fluid containment vessel having an access port for accessing said interior volume, and a cap over said access port and sealing said access port, said cap comprising a puncturable barrier comprising a copolymer of tetrafluoroethylene and perfluoro(alkyl vinyl ether); wherein the copolymer contains between about 40 and 80 weight percent perfluoro(alkyl vinyl ether), and complementally 60 and 20 weight percent tetrafluoroethylene.

17. An apparatus comprising a fluid processing vessel defining an interior volume, said fluid processing vessel having an access port for accessing said interior volume, and a cap over said access port and sealing said access port, said cap comprising a puncturable barrier comprising a copolymer of tetrafluoroethylene and perfluoro(alkyl vinyl ether); wherein the copolymer contains between about 40 and 80 weight percent perfluoro(alkyl vinyl ether), and complementally 60 and 20 weight percent tetrafluoroethylene

18. A cap for a fluid containment vessel, said cap comprising a body intermateable with said fluid containment vessel, said body defining an aperture, and a puncturable, resealable barrier adjacent to said aperture, said barrier comprising a fluorothermoplastic elastomer.

19. A method of sealing a fluid containment vessel having an access port comprising the step of covering said access port with a barrier comprising a fluorothermoplastic elastomer.

20. A method of making a fluid containment vessel comprising forming the vessel of a fluorothermoplastic elastomer.
